(19) United States
(12) Patent Application Publication
(10) Pub. No.: US 2006/0157624 A1
(43) Pub. Date: Jul. 20, 2006

(54) Mouse pad structure

(76) Inventor: Jau-Chi Lai, Banchiau City (TW)

Correspondence Address: Jau-Chi Lai, P.O. Box No. 6-57, Junghe, Taipei 235, TW

(21) Appl. No.: 10/632,982

(22) Filed: Aug. 4, 2003

(51) Int. Cl. B43L 15/00

(52) U.S. Cl. 248/118.1

(57) ABSTRACT

A mouse pad structure consists of a body proper which is a hard flat panel on which is a hollow hole. The side of the hollow hole has a hole of smaller diameter connecting both of which is a groove for housing a mouse cord. A thumb can go through the hollow hole from the bottom to hold the panel while the other hand is free to operate the mouse on the panel. A plurality of protrusions or an anti-slippery with protrusions can be placed on the bottom of the panel to provide inertia when putting the panel on a table top or flat surface. The protrusions elevates the panel to prevent mouse cord in the groove from being compressed.

### BACKGROUND OF THE INVENTION

(a) Field of the Invention

The invention relates to a mouse pad wherein a hole for a thumb to go through exists.

(b) Description of the Prior Art

In order for a mouse, the best partner to a computer, to move smoothly, a compatible mouse pad is necessary. Normally, a user places a mouse pad on a table or on a flat surface; however, the mouse pad usually takes up very much space in a way that documents sometimes cover up the mouse pad. Moreover, the material used for a mouse pad is mostly soft foam sponge or thin plastic resulting in that the mouse pad is unable to be used on a soft (such as a sofa) surface. Even if the user wants to support the mouse pad by hand, he couldn't use the mouse pad properly due to lack of a handle structure.

### SUMMARY OF INVENTION

The invention consists of a mouse pad wherein a hole for a thumb to go through to hold the mouse pad exists so that the mouse pad does not have to be placed on a table or a flat surface in order to use the mouse, thus saving space and breakthrough the limitation by space on using a mouse pad.

The structure of the invention consists of a mouse pad which is a hard flat panel having a hollow hole. On the side of a hole is another hole of smaller diameter which forms a groove of the same diameter to the edge of the panel for housing the mouse cord. A thumb can go through the hollow hole to hold the panel while the other hand can operate the mouse on the panel. In addition, a plurality of protrusions or an anti-slippery pad can be placed under the panel to increase inertia. The protrusions not only provides inertia to the panel when placing the panel on a table top or a flat surface but also facilitates the mouse cord from being compressed directly under the panel.

To enable a further understanding of the said objectives and the technological methods of the invention herein, the brief description of the drawings below is followed by the detailed description of the preferred embodiment.

### BRIEF DESCRIPTION OF THE DRAWINGS

FIG. 1 shows a perspective view of the entire structural combination according to the invention.

FIG. 1A shows a cross-sectional schematic view taken from A-A of FIG. 1 according to the invention.

FIGS. 2 and 3 show a view of the complete assembly in use according to the invention.

### DETAILED DESCRIPTION OF THE PREFERRED EMBODIMENTS

To better understand the characteristics and novelties of the invention, descriptions shall be given with the accompanying drawings hereunder.

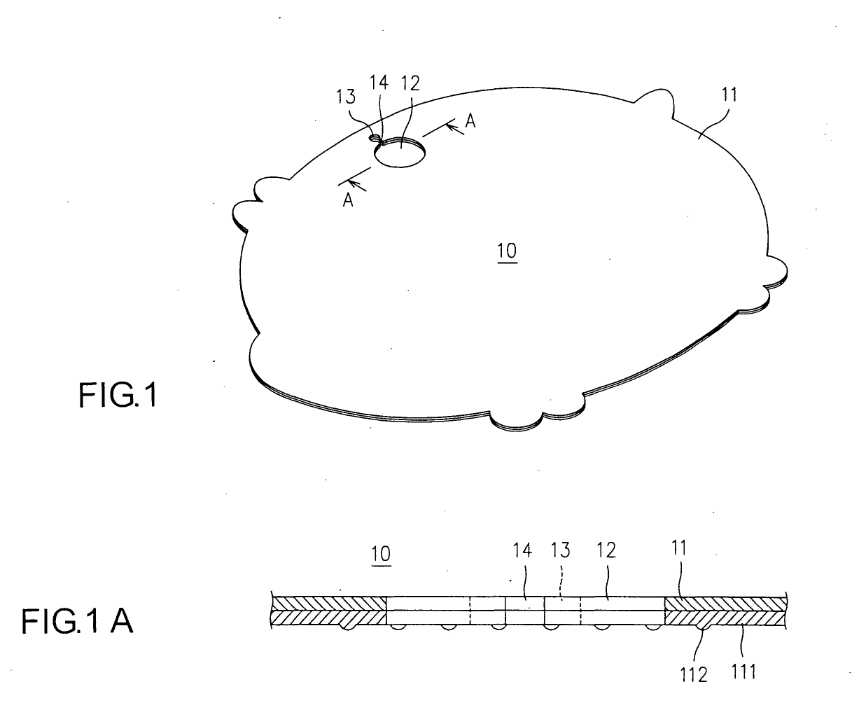

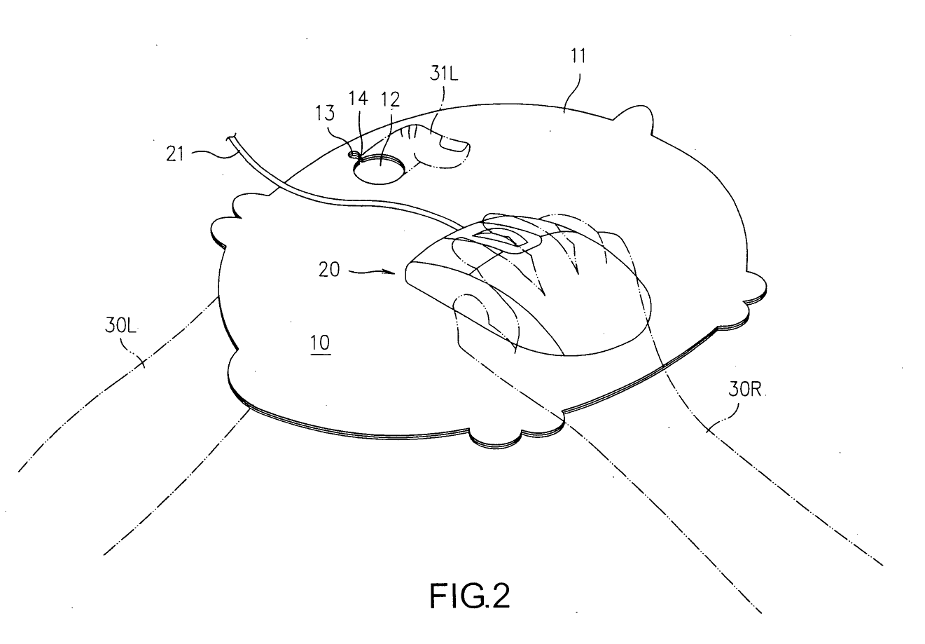

Referring to FIGS. 1 and 1A, the invention showing a mouse pad consists of a body proper (10) which is a hard flat panel (11), an anti-slippery pad (111) under the panel (11), a plurality of protrusions (112) at the bottom surface of the anti-slippery pad (111), a hollow hole (12) to go through the panel (11), a hole of smaller diameter (13) on the side of the hollow hole (12), a groove (14) connecting the hollow hole (12) and the hole of smaller diameter (13)

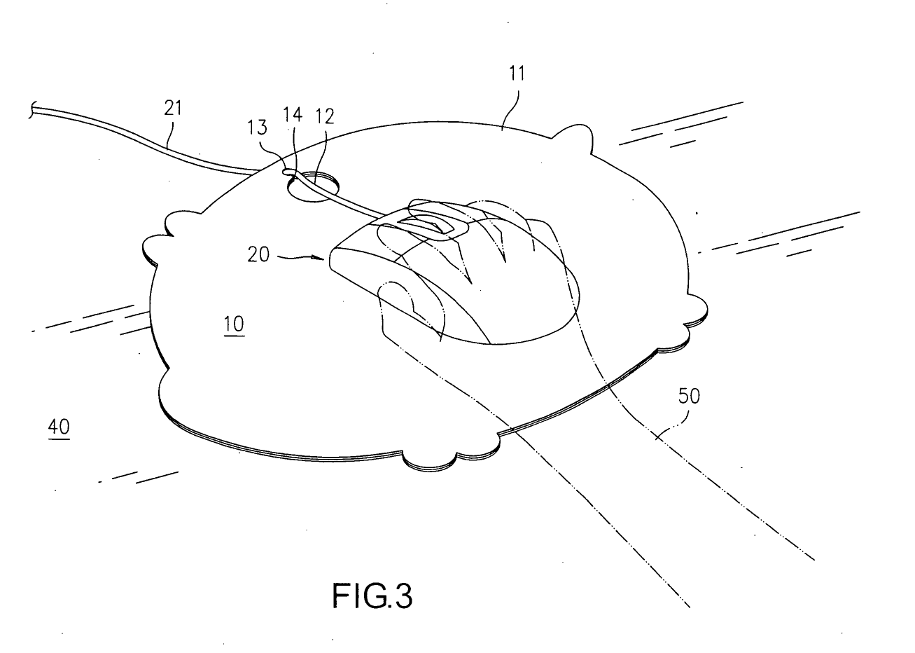

Referring to FIG. 2, the thumb (31L) on the left hand (30L) of a user can go through the hollow hole (12) and hold the panel (11). The right hand (30R) can operate the mouse (20) on the panel (11). If the user is left handed, he simply switches hands while the entire procedure for using remains the same. The panel (11) is of certain rigidity to support the mouse (20) to be used on top without having to place the panel (11) on a table top or hard surface—saving a lot of space.

Referring to FIG. 3, the panel (11) can also be placed on a table top (40) so that the mouse cord (21) of the mouse (20) can go through in the groove (14) in the smaller hole (13). A plurality of protrusions (112) formed at the bottom of the panel (11) elevates the panel (11) to prevent the mouse cord (21) from being compressed. Moreover, the bottom of the panel (11) has an anti-slippery pad (111) to provide inertia so when the hand (50) is operating the mouse (20) on the panel (11), the panel (11) will not be displaced.

In conclusion, the invention provides a type of mouse pad wherein a hollow hole exists for a thumb to go through without having to place the mouse pad on a table top or flat surface to save space and to achieve practicality.

It is of course to be understood that the embodiment described herein is merely illustrative of the principles of the invention and that a wide variety of modifications thereto may be effected by persons skilled in the art without departing from the spirit and scope of the invention as set forth in the claims.

What is claimed is:

1. A mouse pad structure comprising
a body proper in a shape of a hard panel; and a hollow hole to go through the panel.

2. The mouse pad structure as recited in claim 1, wherein one side of the hollow hole has a hole of smaller diameter which is connected via a groove to the hollow hole.

3. The mouse pad structure as recited in claim 1, wherein the width of the groove is narrower than that of the smaller hole.

4. The mouse pad structure as recited in claim 1, wherein the position of the hole of smaller diameter is not limited to a certain location on the panel.

5. The mouse pad structure as recited in claim 1, wherein the bottom of the panel has a plurality of protrusions.

6. The mouse pad structure as recited in claim 1, wherein the bottom of the panel has an anti-slippery pad which also has a plurality of protrusions.
